(19) United States
(12) Patent Application Publication
(10) Pub. No.: US 2023/0126030 A1
(43) Pub. Date: Apr. 27, 2023

(54) SYSTEM AND METHOD FOR PROVIDING A RESPONSE TO A CODE-MIX USER QUERY

(71) Applicant: FLIPKART INTERNET PRIVATE LIMITED, Bengaluru (IN)

(72) Inventors: MANDAR KULKARNI, Pune (IN); NIKESH GARERA, Bangalore (IN); SUBODH KUMAR, Bangalore (IN)

(73) Assignee: FLIPKART INTERNET PRIVATE LIMITED, Bengaluru (IN)

(21) Appl. No.: 17/969,474

(22) Filed: Oct. 19, 2022

(30) Foreign Application Priority Data
Oct. 22, 2021 (IN) 202141048096

(51) Int. Cl. G06F 16/33; G06F 40/49; G06F 40/58

(52) U.S. Cl. CPC G06F 16/3337; G06F 40/49; G06F 40/58

(57) ABSTRACT

A system and method for providing a response to at least one code-mix user query on a digital platform. The method encompasses receiving, by a transceiver unit, the at least one code-mix user query at the digital platform. The method thereafter comprises translating dynamically, by a translation engine, the at least one code-mix user query in a first language based on a pre-trained and fine-tuned sub-system, wherein: the sub-system is pre-trained based on a pre-existing first language corpus, and the sub-system is fine-tuned based on a parallel corpus of one or more pre-existing code-mix user queries. Further the method encompasses identifying and providing, by a response generator, the response to the at least one code-mix user query based at least on the dynamic translation of the at least one code-mix user query.

### RELATED APPLICATION

This application claims priority under 35 U.S.C. § 119 to Indian Patent Application No. 202141048096, filed on Oct. 22, 2021, the entire contents of which are incorporated herein by reference.

### TECHNICAL FIELD

The present invention generally relates to data science and more particularly to systems and methods for providing a response to at least one code-mix user query on a digital platform.

### BACKGROUND OF THE DISCLOSURE

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

In order to provide various facilities to users of electronic devices, a number of technologies are developed over a period of time. Some of these technologies provide to the users, facilities such as to get information and/or to avail any service at any instant of time via accessing digital platforms on the electronic devices. In order to search a particular product or a service or such similar data over the digital platforms, the users are required to initiate a search query for said particular product or service or such similar data, respectively. The search query may be a text or a voice query in any language. Also, as the search query may be in any language, a translation of said search query (for instance in English) is required to execute various operations to generate the response to the search query. Therefore, a good understanding of search queries is required to enhance an experience of the users with the digital platforms.

Also, an e-commerce platform is such a digital platform that can be accessed by the users on the electronic devices such as a smartphone to buy and/or sell various products online. In order to search a product over the e-commerce platform, a user of the e-commerce platform is required to initiate a search query for said product. Once the search query is initiated by the user, it is then analyzed to translate it into a specific language (such as English), wherein the translation in is done in order to execute subsequent workflows such as retrieving relevant products from a database, query intent classification etc. to further generate the response to said search query. Therefore, the translation of a search query is important to provide a response to said search query.

To provide a response to a search query, a number of solutions have been developed over a period of time. For instance, some of the known technologies provide a solution to analyze the search query to identify the context of the search query which further helps to generate a response to said search query. Also, some other known technologies provide a solution to translate contents present in one language to another language. However, none of the existing technologies provide a solution to generate a response to a code-mix search query (i.e. a user query present in more than a single language, where such languages may be written in a script of a specific language) initiated by a user. Although the currently known solutions translate a text present in a single language to another language based on first detecting a language of the text that is to be translated, these currently known solutions fail to: detect multiple language text (may or may not be written in a script of a specific language), and convert such multiple language text in a required language. Furthermore, the currently known solutions to translate the text present in a single language to another language are also limited to translation of simple texts and fail to translate search queries at least due to factors such as large variations in the search queries, non-standard query format, free flowing text, etc.

Therefore, there are a number of limitations of the current solutions and there is a need in the art to provide a method and system for providing a response to at least one code-mix user query on a digital platform.

### SUMMARY OF THE DISCLOSURE

This section is provided to introduce certain objects and aspects of the present invention in a simplified form that are further described below in the detailed description. This summary is not intended to identify the key features or the scope of the claimed subject matter.

In order to overcome at least some of the drawbacks mentioned in the previous section and those otherwise known to persons skilled in the art, an object of the present invention is to provide a method and system for providing a response to at least one code-mix user query (i.e. a user query present in more than a single language, where such languages may be written in a script of a specific language (for instance: English)). Also, an object of the present invention is to provide a code-mix search query translation with transfer learning using transformers. Another object of the present invention is to bring e-commerce to tier-2 and tier-3 cities and democratizing the e-commerce platform by providing a good understanding of search queries written in regional languages. Further, an object of the present invention is to translate code-mix search queries to English language in order to execute subsequent workflows such as retrieving relevant products from a database, query intent classification etc. Also, an object of the present invention is to use transformer model to translate code-mix queries to English. Another object of the present invention is to effectively perform translation of the code-mix queries with a limited amount of labeled data. Further, an object of the present invention is to use publicly available models that are pre-trained on large English text to warm start a transformer fine-tuning. Another object of the present invention is to use noisy character level transliteration with an existing bi-lingual parallel corpus to overcome limitation of non-availability of large parallel training corpus. Yet another object of the present invention is to use a pre-trained transformer model fine-tuned with data augmentation loss along with supervised training objective, in order to further reduce the required amount of labeled data.

Furthermore, in order to achieve the aforementioned objectives, the present invention provides a method and system for providing a response to at least one code-mix user query on a digital platform.

A first aspect of the present invention relates to the method for providing a response to at least one code-mix user query on a digital platform. The method encompasses receiving, by a transceiver unit, the at least one code-mix user query at the digital platform. The method thereafter comprises translating dynamically, by a translation engine, the at least one code-mix user query in a first language based on a pre-trained and fine-tuned sub-system, wherein: the sub-system is pre-trained based on a pre-existing first language corpus, and the sub-system is fine-tuned based on a parallel corpus of one or more pre-existing code-mix user queries. Further the method encompasses identifying and providing, by a response generator, the response to the at least one code-mix user query based at least on the dynamic translation of the at least one code-mix user query.

Another aspect of the present invention relates to a system for providing a response to at least one code-mix user query on a digital platform. The system comprises a transceiver unit, configured to receive, the at least one code-mix user query at the digital platform. The system further comprises a translation engine, configured to dynamically translate, the at least one code-mix user query in a first language based on a pre-trained and fine-tuned sub-system, wherein: the sub-system is pre-trained based on a pre-existing first language corpus, and the sub-system is fine-tuned based on a parallel corpus of one or more pre-existing code-mix user queries. The system also comprises a response generator, configured to identify and provide, the response to the at least one code-mix user query based at least on the dynamic translation of the at least one code-mix user query.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary block diagram of a system [100], for providing a response to at least one code-mix user query on a digital platform, in accordance with exemplary embodiments of the present invention.

FIG. 2 illustrates an exemplary method flow diagram [200], for providing a response to at least one code-mix user query on a digital platform, in accordance with exemplary embodiments of the present invention.

The foregoing shall be more apparent from the following more detailed description of the disclosure.

### DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from a transceiver unit, a translation engine, a response generator, a processing unit, a storage unit and any other such unit(s) which are required to implement the features of the present disclosure.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

As disclosed in the background section, existing technologies have many limitations and in order to overcome at least some of the limitations of the prior known solutions, the present disclosure provides a solution for providing a response to at least one code-mix user query on a digital platform. More specifically, search queries received on digital platforms such as an e-commerce platform are mainly code-mix user/search queries (i.e. queries written with words from different languages). In an instance a code-mix user query received on an e-commerce platform may be in Hinglish, i.e. a query in which one or more words are Hindi written in English script. For instance, ‘battery wala cycle’, ‘chapal boys office’, or ‘agarbatti stand copper’ etc. are exemplary code-mix search queries where ‘wala’, ‘chapel’ and ‘agarbatti’ in the exemplary code-mix search queries are Hindi words written in English script.

In order to provide a response to the code-mix search queries, it is important to translate such code-mix search queries to a specific language (such as English). More particularly, such translation helps in executing subsequent workflows required to identify and provide the response to the code-mix search queries. As the prior known solutions fails to efficiently and effectively translate the code-mix search queries to the specific language, the present invention to overcomes this limitation of the currently known solutions by translating the code-mix search queries to the specific language using pre-trained and fine-tuned transformer models. In an implementation, the present invention encompasses use of the pre-trained and fine-tuned transformer models to translate in English language, one or more code-mix user queries received on an e-commerce platform, wherein said translation is performed in order to further identify and provide response for said one or more code-mix search queries.

Furthermore, the transformer models are pre-trained based on a pre-existing specific language corpus and the transformer models are fine-tuned based on a parallel corpus of one or more pre-existing code-mix user/search queries. The present invention encompasses use of the transformer models that are pre-trained on the pre-existing specific language corpus (such as pre-existing large English language text) to warm start the fine-tuning of the transformer models in order to effectively perform translation of the code-mix user queries with limited amount of labeled/tagged data. The well-initialized transformer models are fine-tuned with the parallel corpus of the one or more pre-existing code-mix user queries (such as the parallel corpus of one or more pre-existing Hinglish queries). In an example, the parallel corpus of the one or more pre-existing user code-mix user queries is manually tagged Hinglish-English query data. Also, in an implementation, to create the parallel corpus of the one or more pre-existing code-mix user queries, the present invention encompasses use of noisy character level transliteration with an existing bi-lingual parallel corpus (such as an existing parallel corpus for translation of native language (for instance: Hindi) to specific language (for instance: English)). The use of noisy character level transliteration with the existing bi-lingual parallel corpus overcomes challenges related to non-availability of large parallel training corpus (i.e. large parallel corpus of the one or more pre-existing code-mix user queries). Also, to further reduce the required amount of labeled/tagged data, the present invention also encompasses further fine-tuning the pre-trained transformer models based on data augmentation loss and supervised training objective.

Therefore, the present invention provides a novel solution of providing a response to at least one code-mix user query on a digital platform. The present invention also provides a technical effect and technical advancement over the currently known solutions by efficiently and effectively translating one or more code-mix user queries. Also, the present invention provides a technical advancement over the currently known solutions at least by identifying and providing a response to the one or more code-mix user queries. The present invention also provides a technical advancement over the currently known solutions by translating code-mix search queries to a specific language using pre-trained and fine-tuned transformer models. Also the present invention provides a technical advancement over the currently known solutions by efficiently and effectively reducing the size of parallel corpus required to fine-tune the transformer models.

Hereinafter, exemplary embodiments of the present disclosure will be described in detail with reference to the accompanying drawings so that those skilled in the art can easily carry out the present disclosure.

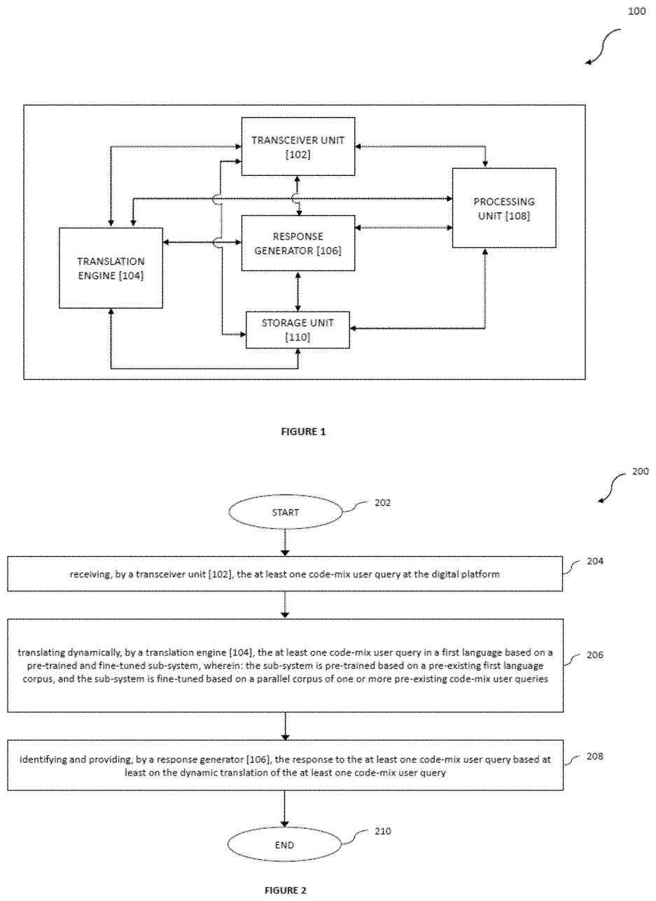

Referring to FIG. 1, an exemplary block diagram of a system [100] for providing a response to at least one code-mix user query on a digital platform is shown. The system [100] comprises at least one transceiver unit [102], at least one translation engine [104], at least one response generator [106], at least one processing unit [108] and at least one storage unit [110]. Also, all of the components/units of the system [100] are assumed to be connected to each other unless otherwise indicated below. Also, in FIG. 1 only a few units are shown, however, the system [100] may comprise multiple such units or the system [100] may comprise any such numbers of said units, as required to implement the features of the present disclosure. Further, in an implementation, the system [100] may be present in a server device to implement the features of the present invention.

The system [100] is configured to provide a response to at least one code-mix user query on a digital platform, with the help of the interconnection between the components/units of the system [100]. The transceiver unit [102] of the system [100] is connected to the at least one translation engine [104], the at least one response generator [106], the at least one processing unit [108] and the at least one storage unit [110]. Also, the transceiver unit [102] may include but not limited to a transmitter to transmit data to one or more destinations and a receiver to receive data from one or more sources. Further, the transceiver unit [102] may include any other similar unit obvious to a person skilled in the art, to implement the features of the present invention. The transceiver unit [102] may convert data or information to signals and vice versa for the purpose of transmitting and receiving, respectively. Furthermore, the transceiver unit [102] is configured to receive, the at least one code-mix user query at the digital platform. In a preferred implementation the digital platform is an e-commerce platform and the at least one code-mix user query may be received at the e-commerce platform to search product(s) and/or service(s). The at least one code-mix user query comprises a combination of a first language and one or more native languages. In an implementation, the one or more native languages may be written in a first language script, but the same is not limited thereto. Also, in an implementation, the first language is a language which is required to execute certain workflows such as retrieving relevant products from a database, query intent classification etc. to further identify and provide the response to the at least one code-mix user query. Also, in an example the first language may be English language and a native language may be Hindi language, therefore in the given example a code-mix user query is in Hinglish. A few examples of user queries in Hinglish may include but not limited to ‘round gale wali t-shirt’, ‘badi screen wala phone’, or ‘ABC phone ka charger’ etc. where ‘gale’, wali’, ‘wala’ and ‘ka’ are Hindi words written in English script.

Once the at least one code-mix user query is received at the digital platform by the transceiver unit [102], the transceiver unit [102] is thereafter configured to provide the same to the translation engine [104]. The translation engine [104] may include but not limited to one or more units capable of translating one or more languages to a required language. More specifically, the translation engine [104] is configured to dynamically translate, the at least one code-mix user query in the first language based on a pre-trained and fine-tuned sub-system. In a preferred implementation the sub-system is a transformer model. Therefore, in the given implementation the translation engine [104] is configured to dynamically translate, the at least one code-mix user query in the first language based on a pre-trained and fine-tuned transformer model. Also, the transformer model may consist of an encoder and a decoder architecture. The encoder maps an input sequence to an encoded representation through a series of multi-head self-attention layers, dense and normalization layers. The decoder may have similar architecture as the encoder with two differences. Firstly, the decoder may consist of masked self-attention layers which restricts the decoder from using an information from future tokens. Secondly, in addition to the self-attention blocks, it may have cross attention layers which use the encoder representations in attention blocks. Also, the decoder model is an auto-regressive model which eventually generates an output text. Furthermore, an important component of the transformer model is a scaled dot-product attention module which enable the transformer model to capture contextual information from relevant tokens in a sentence. Also, to capture token ordering, the transformer model uses positional embedding as an additive component to token embedding.

Furthermore, the sub-system is pre-trained based on a pre-existing first language corpus. In an implementation the pre-existing first language corpus is pre-existing English language corpus. The pre-existing English language corpus may comprise a pre-existing large text data of English language. Therefore, in the given implementation the sub-system is pre-trained based on the pre-existing large text data of English language. Also, the sub-system is fine-tuned based on a parallel corpus of one or more pre-existing code-mix user queries. The parallel corpus of the one or more pre-existing user code-mix user queries is manually tagged code-mix language-first language query data. For instance, in an implementation, where at least one code-mix user query is Hinglish user query, the parallel corpus of the one or more pre-existing user code-mix user queries is manually tagged Hinglish-English query data. Also, in an implementation the parallel corpus of one or more pre-existing code-mix user queries is generated by the processing unit [108] by firstly detecting, an available corpus for translation of one or more native language text to first language text and thereafter by transliterating, the one or more pre-existing code-mix user queries based on the detected available corpus. The available corpus for translation of the one or more native language text to the first language text is an existing bi-lingual parallel corpus. For example, where at least one code-mix user query is at least one Hinglish user query, to generate a parallel corpus of one or more pre-existing Hinglish queries the processing unit [108] is firstly configured to detect an existing bi-lingual (Hindi-English) parallel corpus for translation of one or more Hindi language text to English language text. Thereafter, the processing unit [108] is configured to transliterate the one or more pre-existing Hinglish queries based on the detected Hindi-English parallel corpus. More specifically, a Hindi text present in the one or more pre-existing Hinglish queries is transliterated to an English text based on the detected Hindi-English parallel corpus to further transliterate the one or more pre-existing Hinglish queries. Furthermore, the transliteration may be a character level noisy transliteration. In an implementation a simple character level transliteration may be used and to handle a noise during training of the sub-system a label smoothing technique may be used. The use of noisy character level transliteration with the existing bi-lingual parallel corpus overcomes challenges related to non-availability of large parallel training corpus (i.e. large parallel corpus of the one or more pre-existing code-mix user queries).

Also, in the preferred implementation where the translation engine [104] is configured to dynamically translate, the at least one code-mix user query in the first language based on the pre-trained and fine-tuned transformer model. The transformer model is pre-trained on the pre-existing first language corpus to warm start the fine-tuning of the transformer model in order to effectively perform translation of the at least one code-mix user query with limited amount of labeled/tagged data. The well-initialized transformer model is fine-tuned based on the parallel corpus of the one or more pre-existing code-mix user queries, where the parallel corpus of the one or more pre-existing code-mix user queries is a limited amount of labeled/tagged data. In an example the parallel corpus comprises a labeled/tagged data associated with 50 thousand pre-existing code-mix user queries. Also, there may be multiple possibilities for transformer model initialization such as including but not limited to initializing the encoder and the decoder of the transformer model separately with pre-trained checkpoints such as BERT and GPT respectively, and using pre-trained transformer models such as T5, BART etc.

Furthermore, in an implementation, the fine-tuning of the sub-system is further based on a combination of a labelled loss and an un-labelled loss. The labelled loss is a loss associated with the parallel corpus of the one or more pre-existing code-mix user queries and the un-labelled loss is an augmentation loss. Therefore, in the given implementation, the sub-system is further fine-tuned based on a linear combination of the loss associated with the parallel corpus and the augmentation loss. Also, for data augmentation in an implementation data augmentation strategy such as dropping random characters from the at least one code-mix user query, masking words from the at least one code-mix user query, auto-encoder strategy etc. are used.

Once the sub-system is pre-trained and fine-tuned, the translation engine [104] dynamically translates the at least one code-mix user query in the first language based on the pre-trained and fine-tuned sub-system. Also, based on the implementation of the features of the present invention translation of some exemplary code-mix user queries in the first language is provided below in Table 1. More specifically, the Table 1 depicts the English translations of Hinglish queries based on the implementation of the features of the present invention.

| Hinglish query | English Translation |
|---|---|
| anarkali chudi | anarkali bangle |
| chapal boys office | slipper boys office |
| baccha sweater | baby sweater |
| blazer wala top | blazer top |

Further, once the at least one code-mix user query is dynamically translated in the first language by the translation engine [104] based on the pre-trained and fine-tuned sub-system, the at least one translated code-mix user query is provided to the response generator [106] by the translation engine [104]. The response generator [106] may include but not limited to one or more units configured to provide a response to the at least one code-mix user query. More specifically, the response generator [106] is configured to identify and provide, the response to the at least one code-mix user query based at least on the dynamic translation of the at least one code-mix user query. As the at least one code-mix user query is dynamically translated in the first language, various workflows such as including but not limited to retrieving relevant products from the database, query intent classification etc. are executed based on the first language of the at least one code-mix user query. Furthermore, based on the execution of such workflows the response to the at least one code-mix user query is identified. Further the identified response to the at least one code-mix user query is provided at the digital platform by the response generator [106].

Referring to FIG. 2 an exemplary method flow diagram [200], for providing a response to at least one code-mix user query on a digital platform, in accordance with exemplary embodiments of the present disclosure is shown. In an implementation the method is performed by the system [100]. Further, in an implementation, the system [100] is connected to a server unit to implement the features of the present disclosure. Also, as shown in FIG. 2, the method starts at step [202].

Thereafter, at step [204] the method comprises receiving, by a transceiver unit [102], the at least one code-mix user query at the digital platform. In a preferred implementation the digital platform is an e-commerce platform and the at least one code-mix user query may be received at the e-commerce platform to search product(s) and/or service(s). The at least one code-mix user query comprises a combination of a first language and one or more native languages. In an implementation, the one or more native languages may be written in a first language script, but the same is not limited thereto. Also, in an implementation, the first language is a language which is required to execute certain workflows such as retrieving relevant products from a database, query intent classification etc. to further identify and provide the response to the at least one code-mix user query. Also, in an example the first language may be English language and a native language may be any native language, therefore in the given example a code-mix user query is in combination of both English and said native language.

Once the at least one code-mix user query is received at the digital platform by the transceiver unit [102], the method encompasses providing the same by the transceiver unit [102] to a translation engine [104]. Next at step [206] the method comprises translating dynamically, by the translation engine [104], the at least one code-mix user query in the first language based on a pre-trained and fine-tuned sub-system. In a preferred implementation the sub-system is a transformer model. Therefore, in the given implementation the method encompasses translating dynamically by the translation engine [104], the at least one code-mix user query in the first language based on a pre-trained and fine-tuned transformer model. Also, in an implementation the transformer model may consists of an encoder and a decoder architecture.

Furthermore, the sub-system is pre-trained based on a pre-existing first language corpus. In an implementation the pre-existing first language corpus is pre-existing English language corpus. The pre-existing English language corpus may comprise a pre-existing large text data of English language. Therefore, in the given implementation the sub-system is pre-trained based on the pre-existing large text data of English language. Also, the sub-system is fine-tuned based on a parallel corpus of one or more pre-existing code-mix user queries. The parallel corpus of the one or more pre-existing user code-mix user queries is manually tagged code-mix language-first language query data. For instance, in an implementation, where at least one code-mix user query is Hinglish user query, the parallel corpus of the one or more pre-existing user code-mix user queries is manually tagged Hinglish-English query data.

Also, in an implementation the parallel corpus is generated by firstly detecting, by a processing unit [108], an available corpus for translation of one or more native language text to first language text and thereafter transliterating, by the processing unit [108], the one or more pre-existing code-mix user queries based on the detected available corpus. The available corpus for translation of the one or more native language text to the first language text is an existing bi-lingual parallel corpus. For example, where at least one code-mix user query is at least one Hinglish user query, to generate a parallel corpus of one or more pre-existing Hinglish queries the method encompasses firstly detecting by the processing unit [108], an existing bi-lingual (Hindi-English) parallel corpus for translation of one or more Hindi language text to English language text. Thereafter, the method encompasses transliterating by the processing unit [108] the one or more pre-existing Hinglish queries based on the detected Hindi-English parallel corpus. More specifically, a Hindi text present in the one or more pre-existing Hinglish queries is transliterated to an English text based on the detected Hindi-English parallel corpus to further transliterate the one or more pre-existing Hinglish queries. Furthermore, the transliteration may be a character level noisy transliteration. In an implementation a simple character level transliteration may be used and to handle a noise during training of the sub-system a label smoothing technique may be used. The use of noisy character level transliteration with the existing bi-lingual parallel corpus overcomes challenges related to non-availability of large parallel training corpus (i.e. large parallel corpus of the one or more pre-existing code-mix user queries).

Also, in the preferred implementation where the method encompasses dynamically translating by the translation engine [104], the at least one code-mix user query in the first language based on the pre-trained and fine-tuned transformer model. The transformer model is pre-trained on the pre-existing first language corpus to warm start the fine-tuning of the transformer model in order to effectively perform translation of the at least one code-mix user query with limited amount of labeled/tagged data. The well-initialized transformer model is fine-tuned based on the parallel corpus of the one or more pre-existing code-mix user queries, where the parallel corpus of the one or more pre-existing code-mix user queries is a limited amount of labeled/tagged data. In an example the parallel corpus comprises a labeled/tagged data associated with 70 thousand pre-existing code-mix user queries. Also, there may be multiple possibilities for transformer model initialization such as including but not limited to initializing the encoder and the decoder of the transformer model separately with pre-trained checkpoints such as BERT and GPT respectively, and using pre-trained transformer models such as T5, BART etc.

Furthermore, in an implementation the fine-tuning of the sub-system is further based on a combination of a labelled loss and an un-labelled loss. The labelled loss is a loss associated with the parallel corpus of the one or more pre-existing code-mix user queries and the un-labelled loss is an augmentation loss. Therefore, in the given implementation, the sub-system is further fine-tuned based on a linear combination of the loss associated with the parallel corpus and the augmentation loss. Also, for data augmentation in an implementation data augmentation strategy such as dropping random characters from the at least one code-mix user query, masking words from the at least one code-mix user query, auto-encoder strategy etc. are used.

Once the sub-system is pre-trained and fine-tuned, the method encompasses dynamically translating by the translation engine [104], the at least one code-mix user query in the first language based on the pre-trained and fine-tuned sub-system. Also, once the at least one code-mix user query is dynamically translated in the first language by the translation engine [104], the at least one translated code-mix user query is provided to a response generator [106] by the translation engine [104]. Further, at step [208] the method comprises identifying and providing, by the response generator [106], the response to the at least one code-mix user query based at least on the dynamic translation of the at least one code-mix user query. As the at least one code-mix user query is dynamically translated in the first language, various workflows such as including but not limited to retrieving relevant products from the database, query intent classification etc. are executed based on the first language of the at least one code-mix user query. Furthermore, based on the execution of such workflows the response to the at least one code-mix user query is identified. Further the identified response to the at least one code-mix user query is provided at the digital platform by the response generator [106].

After providing the response to the at least one code-mix user query on the digital platform, the method terminates at step [210].

Thus, the present invention provides a novel solution of providing a response to at least one code-mix user query on a digital platform. The present invention also provides a technical effect and technical advancement over the currently known solutions by efficiently and effectively translating one or more code-mix user queries. Also, the present invention provides a technical advancement over the currently known solutions at least by identifying and providing a response to the one or more code-mix user queries. The present invention also provides a technical advancement over the currently known solutions by translating code-mix search queries to a specific language using pre-trained and fine-tuned transformer models. Also the present invention provides a technical advancement over the currently known solutions by efficiently and effectively reducing a size of parallel corpus required to fine-tune the transformer models.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

What is claimed is:

1. A method for providing a response to at least one code-mix user query on a digital platform, the method comprising:
receiving, by a transceiver unit [102], the at least one code-mix user query at the digital platform;
translating dynamically, by a translation engine [104], the at least one code-mix user query in a first language based on a pre-trained and fine-tuned sub-system, wherein:
the sub-system is pre-trained based on a pre-existing first language corpus, and
the sub-system is fine-tuned based on a parallel corpus of one or more pre-existing code-mix user queries; and
identifying and providing, by a response generator [106], the response to the at least one code-mix user query based at least on the dynamic translation of the at least one code-mix user query.

2. The method as claimed in claim 1, wherein the parallel corpus is generated by:
detecting, by a processing unit [108], an available corpus for translation of one or more native language text to first language text, and
transliterating, by the processing unit [108], the one or more pre-existing code-mix user queries based on the detected available corpus.

3. The method as claimed in claim 2, wherein the transliteration is a character level noisy transliteration.

4. The method as claimed in claim 1, wherein the at least one code-mix user query comprises a combination of the first language and one or more native languages.

5. The method as claimed in claim 1, wherein the fine-tuning of the sub-system is further based on a combination of a labelled loss and an un-labelled loss.

6. A system for providing a response to at least one code-mix user query on a digital platform, the system comprising:
a transceiver unit [102], configured to receive, the at least one code-mix user query at the digital platform;
a translation engine [104], configured to dynamically translate, the at least one code-mix user query in a first language based on a pre-trained and fine-tuned sub-system, wherein:
the sub-system is pre-trained based on a pre-existing first language corpus, and
the sub-system is fine-tuned based on a parallel corpus of one or more pre-existing code-mix user queries; and
a response generator [106], configured to identify and provide, the response to the at least one code-mix user query based at least on the dynamic translation of the at least one code-mix user query.

7. The system as claimed in claim 6, the system further comprises a processing unit [108] configured to generate the parallel corpus by:
detecting, an available corpus for translation of one or more native language text to first language text, and
transliterating, the one or more pre-existing code-mix user queries based on the detected available corpus.

8. The system as claimed in claim 7, wherein the transliteration is a character level noisy transliteration.

9. The system as claimed in claim 6, wherein the at least one code-mix user query comprises a combination of the first language and one or more native languages.

10. The system as claimed in claim 6, wherein the fine-tuning of the sub-system is further based on a combination of a labelled loss and an un-labelled loss.
